(19) United States
(12) Patent Application Publication
(10) Pub. No.: US 2024/0250952 A1
(43) Pub. Date: Jul. 25, 2024

(54) TECHNIQUES FOR PREVENTING MALWARE ATTACKS IN AN OPERATING SYSTEM ENVIRONMENT

(71) Applicant: Vinay Mamidi, Belmont, CA (US)

(72) Inventor: Vinay Mamidi, Belmont, CA (US)

(21) Appl. No.: 18/101,190

(22) Filed: Jan. 25, 2023

(51) Int. Cl. H04L 9/40

(52) U.S. Cl. CPC H04L 63/105; H04L 63/108; H04L 63/145; H04L 2463/082

(57) ABSTRACT

A method and a system for preventing malware attacks in an Operating System Environment (OSE) is disclosed. The method comprises the step of creating an application allow list for an application running in an OSE and receiving an access request from a user for controlling the application process. Further, upon receiving the access request from a user, the user's credentials are validated using multi-factor authentication. Upon authentication, the user is permitted to control the application processes by adding the user to the application allow list with one or more conditionalities including permission level and time-limit.

### TECHNICAL FIELD

The present disclosure is related to the field of information security. More particularly, the present disclosure is related to methods, techniques, and systems for preventing malware attack in an operating system environment.

### BACKGROUND

Computer related infrastructure comprising hardware as well as software assets form the backbone of every modern day organization. Critical processes and information related day to day activities of the organization may be managed exclusively by such computing infrastructure. Servers that run locally or in a cloud by means of Virtual Machines are often used for processing data stored in local or cloud data bases. Most of these servers run hundreds of applications simultaneously to perform various tasks. The functioning of these applications are managed by an Operating System. Exemplary Operating System Environments (OSE) include Unix, Linux, Netware, and Microsoft. The choice of an OSE depends upon various parameters of the business/organization including but not limited to complexity, use-case, cost, network requirements, location, and the like.

While several hundred application run simultaneously in an OSE, only a handful of them are predominantly accessed/used by most of the users of the organization. For example, in an organization that largely deals with accounting, most of the employees may use the accounting software and the ERMS systems alone. Moreover, the functionalities they access would be limited to their role as well. While the role of most users are limited to “using the application”, admins may be provided with much more control wherein their use may extend to “controlling the application” as well. Hence, the access/permission level required varies with the role played by each user in an organization.

It is well known that an OSE may run a plurality of application processes at the same time. Hence, an intruder (malware) may ideally mimic an ordinary user to gain access into critical applications thereby accessing critical information. A malicious application or a malware is any software designed to cause disruption to a computer infrastructure. They may be used to leak private information, gain unauthorized access to information or systems, deprive access to information. Such intrusion interferes with the an organization's computer security and privacy. Malwares include at least one of computer viruses, worms, Trojan horses, ransomware, spyware, adware, wiper, scareware, and the like. While solutions such as installing antivirus software, firewalls, applying regular patches, performing regular backups, isolating infected systems, and the like, may prevent attacks to an extent, they are not fool proof since modern malware are much smarter and dynamic.

In modern organizations, the computing infrastructure connected to the internet or even local networks constantly face a wide variety of external threats from attackers. The attackers range from individuals and organizations to hostile government agencies. The types of attacks could range from malware attacks, crimeware, eavesdropping, multi-vector attacks, phishing, privilege escalation, spoofing, social engineering, tampering, backdoor attacks, and the like.

U.S. Ser. No. 11/030,303B2 disclose methods, systems, and apparatuses for managing an execution of applications in a computing environment. A whitelist list of applications that are permitted to execute in a computing environment is obtained. For one or more of the applications on the whitelist, a temporal rule is assigned that specifies a time period in which the application is permitted to execute in the computing environment. For instance, the temporal rule may be obtained via a user input or may be determined automatically by analyzing an execution history of the application. Applications are permitted to execute in the computing environment during the time period specified by the temporal rule, and are prevented from executing outside of the time period. By restricting the time period in which an application can execute, the overall vulnerability to malware attacks in a computing environment may be reduced.

U.S. Pat. No. 9,760,712B2 disclose methods and systems for protecting a virtual machine network. In an embodiment, a method involves storing an application whitelist including application-to-user associations in memory such that the application whitelist is immutable by a guest virtual machine, receiving a request to execute an application including an application identifier and a user identifier, comparing the application identifier and the user identifier of the request with the application whitelist, and generating an execution decision indicating whether the requested application can execute on the guest virtual machine.

U.S. Ser. No. 10/158,489B2 discloses an access management system that can provide access to resources by password-less authentication. The access management system can provide multiple layers of security for authentication taking into account risk factors (e.g., device, location, etc.) to ensure authentication without compromising access. Contextual details of a user based on a mobile device can be used for authentication based on possession of a device. Password-less authentication of a user may be enabled by registration of devices and/or a location (e.g., a geographic location) as trusted. Security data embedded with encrypted data can be sent to a first device for password-less authentication of a user at the device. A second device registered with the user can obtain the security data from the first device. The second device can decrypts the data and send the decrypted data to the access management system for verification to enable password-less authentication at the first device.

While the prior-arts suggest various innovative techniques to avoid malware attack and hostile intrusion, they do not make use of modern solutions like multi-factor authentication that can securely and effortlessly verify the authenticity of each user for entitling access to operating system processes. The present disclosure proposes a solution that uses multi factor authentication along with other innovative techniques for validating the credentials of a user and monitoring credentials of the users accessing applications running in an OSE in real time.

### SUMMARY

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present disclosure proposes a solution to prevent malware attack in an Operating System Environment (OSE). Herein, an application allow list is created for each application process running in the OSE. When an access request for controlling the application is received from a user, a multifactor authentication (MFA) process is initiated for validating the credentials of the user. By using MFA for validation before entry, intruders are denied entry at the very first stage. Further, upon validating the user's credentials, the validated user is permitted to control the application processes by adding the user to the application allow list. One or more conditionalities are established while allowing the user to control the application including permission level and time-limit. Furthermore, the technique determines a confidence score for each user, wherein factors determining the confidence score include time elapsed after validation and non-compliance to conditionalities. If the user's confidence score crosses a lower threshold, the user is removed from the application allow list and is prompted to reauthenticate using MFA.

This summary is provided merely for purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1 is a block diagram of the architecture of a user monitoring & authentication system according to the embodiments of the present disclosure;

FIG. 2 is an example flow diagram of a method for preventing malware attack in an OSE according to the embodiments of the present disclosure;

FIG. 3 is a block diagram of an example machine-readable storage medium storing instructions for preventing malware attacks in an OSE according to the embodiments of the present disclosure;

FIG. 4 is an exemplary flow chart disclosing the techniques used for continuously user validation and monitoring for preventing malware attacks in an OSE according to the embodiments of the present disclosure;

The drawings described herein are for illustration purposes only and are not intended to limit the scope of the present subject matter in any way.

### DETAILED DESCRIPTION

In the following description of the embodiments of the invention, reference is made to the accompanying drawings that form a part hereof, and in which are shown by way of illustration specific embodiments in which the invention maybe practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense. The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

According to the embodiments of the present disclosure, a solution to prevent intrusion from malware or a hacker in an OSE is disclosed. In modern computing environments, applications often run in an OSE installed in Virtual Machines that run in a cloud based platform. While local servers are used by some organizations, a majority of organizations prefer cloud based services due to the scalability and flexibility they provide. In either cases, users of organizations access one or more applications for performing various functions depending upon their role in the organization. While some users (normal users) restrict their operations to regular usage of a few prominent applications, advanced users (such as admins) may be provided access to control even system level applications. In any case, most organizations have a complex structure for application access management. Processes followed for granting access permissions are often too complex and filled with loopholes. Intruders often take advantage of such scenarios to gain access to critical application as well as data. Hence, validating the credentials of the users requesting access to application processes and monitoring their usage pattern would significantly reduce malware attacks and resulting data theft.

The present disclosure proposes a robust technique for validating user credentials and monitoring user activity to prevent such malware attacks. Herein, an application allow list maybe created for each of the application running in the OSE. Upon a user requesting access or one or more applications running in the OSE, the authenticity of the user is first validated by using multifactor authentication (MFA). Using modern techniques such as MFA reduces the chances of unauthorised users posing as users of the organization significantly. MFA may use one or more credentials of the organization to validate the authenticity of the user. Organization email or phone number based OTP, device based OTP, device based tokens, IP address based tokens, and the like maybe used in addition to a primary validation means to prevent intruders from being allowed to access the system in the very first stage.

Further, upon validating the user's credentials, the validated user is permitted to control the application processes by adding the user to the application allow list. One or more conditionalities are established while allowing the user to control the application including permission level and time-limit. Herein, each user is provided with a permission level for each application. If a user crosses this permission level, a confidence score attached to the user's profile gets affected resulting in removal of the user from the allow list. Similarly, a time-limit based approach may also be considered. Herein, the user is allowed in the application allow list only for a fixed amount of time after which the user is asked to re-authenticate.

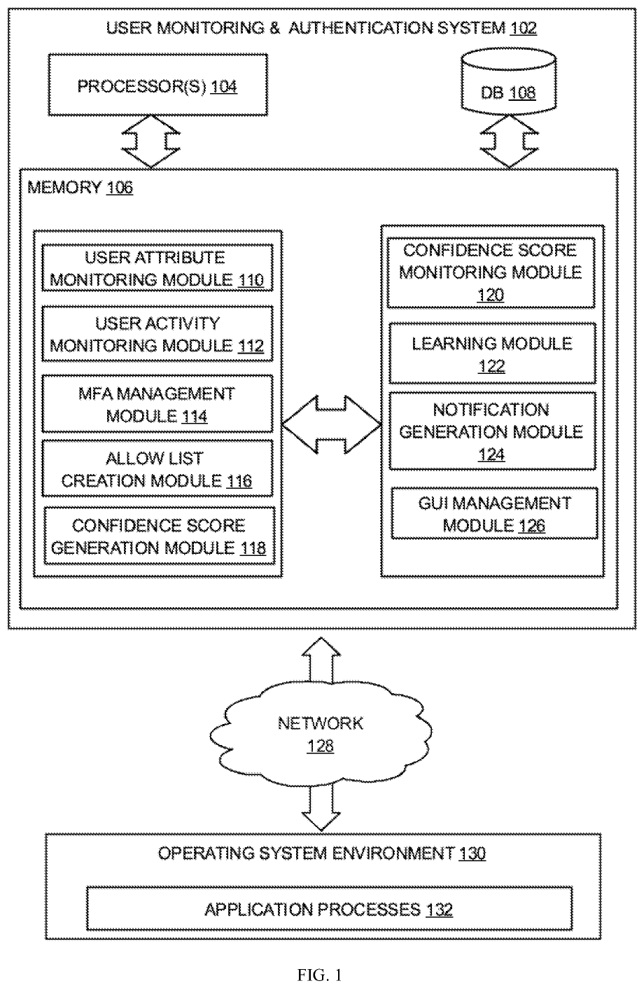

Referring to the figures, FIG. 1 is a block diagram 100 of the architecture of a user monitoring & authentication system according to the embodiments of the present disclosure. FIG. 1 is a block diagram 100 of the user monitoring & authentication system 102 connected to a operating system environment 130 running one or more application processes 132 via a network 128. As shown in FIG. 1, the user monitoring & authentication system 102 may include processor(s) 104 and memory 106 that are communicatively coupled to each other. Further, the user monitoring & authentication system 102 may include a Database (DB) 108 that may be communicatively connected to the memory 106. Furthermore, as shown in FIG. 1, memory 106 may include a user attribute monitoring module (110), a user activity monitoring module (112), an MFA management module (114), an allow list creation module (116), a confidence score generation module (118), a confidence score monitoring module (120), a learning module (122), a notification generation module (124), and a GUI management module (126).

Components of user monitoring & authentication system 102 may be any combination of hardware and programming to implement the functionalities described herein. In some implementations, the programming may be processor 104 executable instructions stored on a non-transitory machine-readable storage medium (e.g., memory 106), and the hardware may include at least one processing resource to retrieve and/or execute those instructions. Processor(s) 104 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. Processor(s) 104 thus may also include the functionality to encode messages and/or data or information. Processor(s) 104 may include, among other things, a clock, an arithmetic logic unit (ALU) and logic gates configured to support operation of processor(s) 104. Further, the processor(s) 104 may include functionality to execute one or more software programs, which may be stored in the memory 106 or otherwise accessible to processor(s) 104.

Memory 106, may store any number of pieces of information, and data, used by the system to implement the functions of the system. The memory 106 may include for example, volatile memory and/or non-volatile memory. Examples of volatile memory may include but are not limited to volatile random-access memory (RAM). The non-volatile memory may additionally or alternatively comprise an electrically erasable programmable read only memory (EEPROM), flash memory, hard drive, and the like. Some examples of the volatile memory include, but are not limited to, dynamic RAM, static RAM, and the like. Some example of the non-volatile memory includes, but are not limited to, hard disks, magnetic tapes, optical disks, programmable read only memory, erasable programmable read only memory, electrically erasable programmable read only memory, flash memory, and the like. Memory 106 may be configured to store information, data, applications, instructions or the like for enabling the system to carry out various functions in accordance with various example embodiments. Additionally, or alternatively, the memory 106 may be configured to store instructions which when executed by processor(s) 104 causes the threat detection and recommendation system 102 to behave in a manner as described in various embodiments.

In one implementation, the network 128 may be a wireless network, a wired network or a combination thereof. The network 128 may be implemented as one of the several types of networks, such as intranet, local area network (LAN), wide area network (WAN), the internet, and the like. The network 128 may either be a dedicated network or a shared network. The shared network represents an association of the several types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 128 may include a variety of network devices, including routers, bridges, servers, computing devices, storage devices, and the like.

During operation, the user attribute monitoring module 110 tracks the details of the user accessing the application in the OSE to flag suspicious users. Attributes monitored include user device information, user location, user id, IP address of the user, and the like. The user activity monitoring module tracks the activities performed by the user to flag suspicious activity. Herein, user activities monitored include session time, storage locations accessed, administrative activities performed, and the like. The MFA management module performs and keeps track of multifactor authentication-based user credential validation. The allow list creation module creates and tracks allow lists for each application and manages addition/removal of users to/from the application allow list. The confidence score generation module 118 and the confidence score monitoring module 120, as their names suggest, generates confidence score for each user and monitors confidence score of users currently occupying the application allow list respectively. The learning module 122 tracks user activity and relates the user activity with historical user activity and generates user pattern. Detailed user profiles are generated by the learning module 112 based on monitoring activity of the user over a period of time. It is an intelligent self-learning software solution. The notification generation module 124 informs user to re-authenticate by sending push notifications. The GUI management module 128 manages the overall look and feel (user interface) of the software application that interacts directly with the end-user.

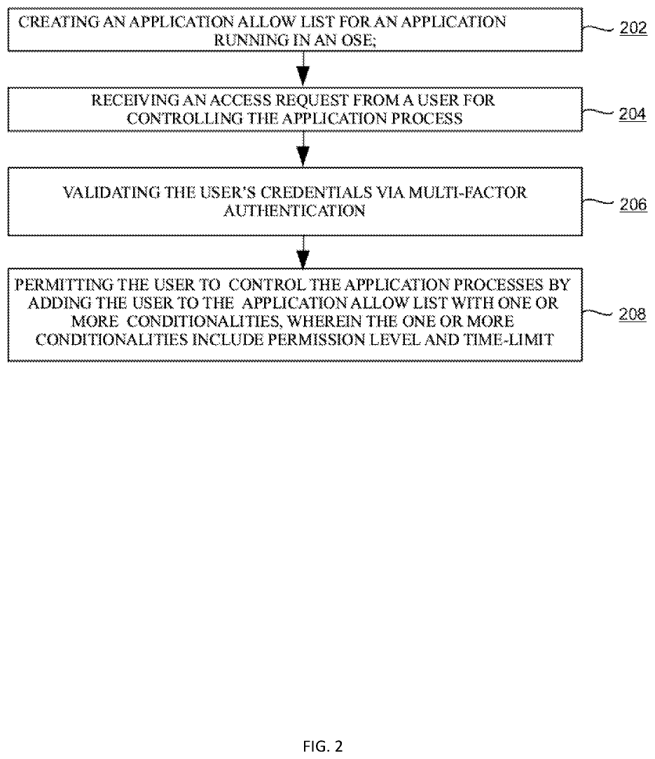

FIG. 2 is an example flow diagram 200 of a method for preventing malware attack in an OSE. The process depicted in FIG. 2 represents generalized illustrations, and that other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. Alternatively, the processes may represent functions and/or actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flowcharts illustrate functional information to design/fabricate circuits, generate programs, or use a combination of hardware and program to perform the illustrated processes.

At 202, the method performs the step of creating an application allow list for an application running in an OSE. At 204, the method performs the step of receiving an access request from a user for controlling the application process. At 206, the method performs the step of validating the user's credentials via multi-factor authentication. At 208, the method performs the step of permitting the user to control the application processes by adding the user to the application allow list with one or more conditionalities, wherein the one or more conditionalities include permission level and time-limit.

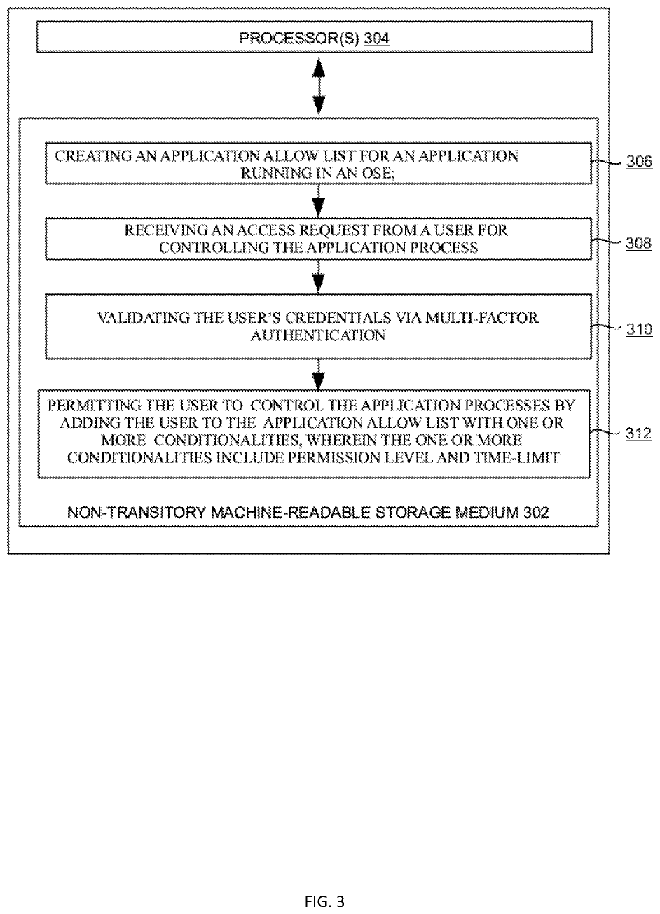

FIG. 3 is a block diagram 300 of an example computing system including instructions stored in a machine-readable storage medium 302 for mitigating cybersecurity performance gaps in an organization. The computing system 300 may include a processor(s) 304 and a non-transitory machine-readable storage medium 302 communicatively coupled through a system bus. The processor 304 may be any type of central processing unit (CPU), microprocessor, or processing logic that interprets and executes machine-readable instructions stored in the machine-readable storage medium 302. The machine-readable storage medium 302 may be a random-access memory (RAM) or another type of dynamic storage device that may store information and machine-readable instructions that may be executed by the processor 304. For example, the machine-readable storage medium 302 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, the machine-readable storage medium 302 may be a non-transitory machine-readable medium. In an example, the machine-readable storage medium 302 may be remote but accessible to computing system 300.

At 306, the machine-readable storage medium instructs the system to create an application allow list for an application running in an OSE. At 308, the machine-readable storage medium instructs the system to receive an access request from a user for controlling the application process. At 310, the machine-readable storage medium instructs the system to validate the user's credentials via multi-factor authentication. At 312, the machine-readable storage medium instructs the system to permit the user to control the application processes by adding the user to the application allow list with one or more conditionalities, wherein the one or more conditionalities include permission level and time-limit.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The solution disclosed herein determines a confidence score for the user, wherein factors determining the confidence score include time elapsed after validation and non-compliance to conditionalities. The confidence score of the user keeps decreasing with time. After a particular amount of time, the confidence score may hit the lower threshold thereby prompting the user to re-validate their authenticity using MFA. Similarly, the confidence score decreases if the user tries to access applications for which the user is not authorized (not added in the application allow list). If the user oversteps the permission level, the confidence score is again affected. In a related embodiment of the present disclosure, upon the learning module creating a detailed profile of the user using user attributes and historical user activity, the system becomes intelligent to assign confidence score based on every user activity. The system may understand the list of activities that are normally performed by the user and if the user deviates from the list of allowed activities, the user may be asked to reauthenticate. The confidence score of the user is affected upon deviation from expected activity. Herein, the user's activities and attributes are monitored to generate a user-specific allow list comprising a list of permissible activities for the user. Each user may be provided with a list of permissible activities that may be performed without affecting the user's confidence score. The user activities monitored include session time, storage locations accessed, administrative activities performed, and the like.

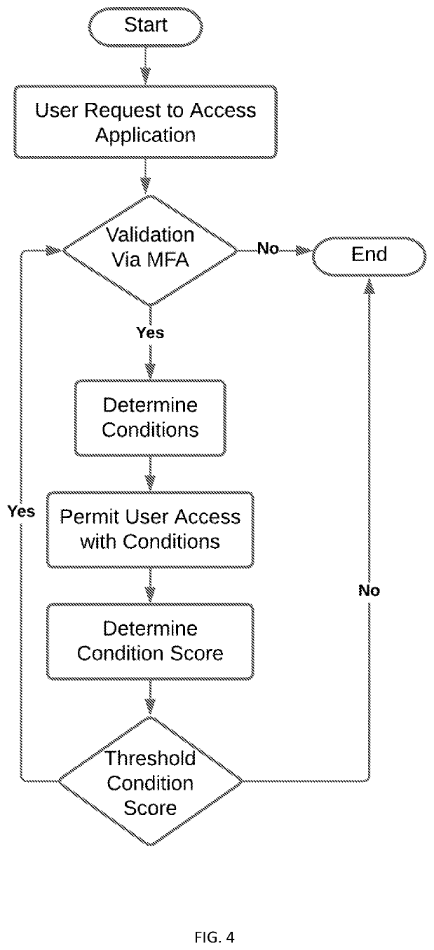

FIG. 4 is an exemplary flow chart disclosing the techniques used for continuously user validation and monitoring for preventing malware attacks in an OSE according to the embodiments of the present disclosure. The process starts at 402 and moves to 404 wherein the user requests access to an application. At 404, a decision is made regarding allowing the user to access the application by performing user validation using MFA. If the user fails, the process moves to step 406 and ends. Upon the user successfully validating credentials, the process moves to 408 wherein conditions are determined for allowing the user. Conditions include time limit and level of access to the application depending upon the user's role. At 410, the user is allowed to access the application. At 412, the user's confidence score is determined simultaneously. At 414, it is verified whether the user's confidence score has reached a lower threshold. Steps 412-414 are recurring steps that keep repeating at regular intervals. If the threshold score is hit, the user is asked to reauthenticate using MFA to continue access to the application.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A processor-implemented method for preventing malware attacks in an Operating System Environment (OSE), comprising:
creating an application allow list for an application running in an OSE;
receiving an access request from a user for controlling the application process;
validating the user's credentials via multi-factor authentication; and
upon validating the user's credentials, permitting the user to control the application processes by adding the user to the application allow list with one or more conditionalities, wherein the one or more conditionalities include permission level and time-limit.

2. The processor-implemented method for preventing malware attacks in an Operating System Environment (OSE) of claim 1, further comprising:
determining a confidence score for the user, wherein factors determining the confidence score include time elapsed after validation and non-compliance to conditionalities; and
removing the user from the application allow list upon the user's confidence score crossing a predefined threshold.

3. The processor-implemented method for preventing malware attacks in an Operating System Environment (OSE) of claim 2, wherein user activities and user attributes are monitored to generate a user-specific allow list comprising a list of permissible activities for the user.

4. The processor-implemented method for preventing malware attacks in an Operating System Environment (OSE) of claim 3, wherein the user attributes monitored include geographical location, IP address, and user device information.

5. The processor-implemented method for preventing malware attacks in an Operating System Environment (OSE) of claim 3, wherein the user activities monitored include one or a combination of session time, storage locations accessed, and administrative activities performed.

6. The processor-implemented method for preventing malware attacks in an Operating System Environment (OSE) of claim 2, wherein upon removing the user from the application allow list, prompting the user to re-validate the user's credentials using multifactor authentication.

7. A system for preventing malware attacks in an Operating System Environment (OSE), comprising:
at least one processor; and
a memory communicatively coupled to the processor storing instructions thereon that, when executed by the at least one processor, cause the system to:
create an application allow list for an application running in an OSE;
receive an access request from a user for controlling the application process;
validate the user's credentials via multi-factor authentication; and
upon validating the user's credentials, permit the user to control the application processes by adding the user to the application allow list with one or more conditionalities, wherein the one or more conditionalities include permission level and time-limit.

8. The system for preventing malware attacks in an Operating System Environment (OSE) of claim 7, wherein the instructions when executed further causes the system to:
determine a confidence score for the user, wherein factors determining the confidence score include time elapsed after validation and non-compliance to conditionalities; and
remove the user from the application allow list upon the user's confidence score crossing a predefined threshold.

9. The system for preventing malware attacks in an Operating System Environment (OSE) of claim 8, wherein user activities and user attributes are monitored to generate a user-specific allow list comprising a list of permissible activities for the user.

10. The system for preventing malware attacks in an Operating System Environment (OSE) of claim 9, wherein the user attributes monitored include geographical location, IP address, and user device information.

11. The system for preventing malware attacks in an Operating System Environment (OSE) of claim 9, wherein the user activities monitored include one or a combination of session time, storage locations accessed, and administrative activities performed.

12. The system for preventing malware attacks in an Operating System Environment (OSE) of claim 8, wherein upon removing the user from the application allow list, prompting the user to re-validate the user's credentials using multifactor authentication.

13. A non-transitory computer readable medium storing instructions thereon that, when executed by at least one processor, cause a computer system to:
create an application allow list for an application running in an OSE;
receive an access request from a user for controlling the application process;
validate the user's credentials via multi-factor authentication; and
upon validating the user's credentials, permit the user to control the application processes by adding the user to the application allow list with one or more conditionalities, wherein the one or more conditionalities include permission level and time-limit.

14. The non-transitory computer readable medium of claim 13, further cause the computer system to:
determine a confidence score for the user, wherein factors determining the confidence score include time elapsed after validation and non-compliance to conditionalities; and
remove the user from the application allow list upon the user's confidence score crossing a predefined threshold.

15. The non-transitory computer readable medium of claim 14, wherein user activities and user attributes are monitored to generate a user-specific allow list comprising a list of permissible activities for the user.

16. The non-transitory computer readable medium of claim 15, wherein the user attributes monitored include geographical location, IP address, and user device information.

17. The non-transitory computer readable medium of claim 15, wherein the user activities monitored include one or a combination of session time, storage locations accessed, and administrative activities performed.

18. The non-transitory computer readable medium of claim 14, wherein upon removing the user from the application allow list, prompting the user to re-validate the user's credentials using multifactor authentication.
